(19) United States
(12) Patent Application Publication
(10) Pub. No.: US 2026/0268358 A1
(43) Pub. Date: Sep. 10, 2026

(54) Cloud-Native Activation and Segmentation

(71) Applicant: LiveRamp, Inc., San Francisco, CA (US)

(72) Inventors: Burak Emre Kabakci, London (GB); Joseph Shannon Duncan, Conway, AR (US); Grzegorz Michal Caban, London (GB)

(21) Appl. No.: 19/165,900

(22) PCT Filed: Feb. 9, 2024
(86) PCT No.: PCT/US2024/015163

§ 371 Date: Sep. 16, 2025

Related U.S. Application Data
(60) Provisional application No. 63/453,573, filed on Mar. 21, 2023.

(51) Int. Cl. G06Q 30/0204; G06F 16/242

(52) U.S. Cl. CPC G06Q 30/0204; G06F 16/2433

(57) ABSTRACT

A cloud-native data activation and segmentation system uses only a single column of data, such as an anonymized customer identifier, rather than sending an entire dataset out of the cloud environment to the provider systems. The reduced data requirement is the result of the fact that computation is pushed down to the data owner's cloud-based data warehouse environment. The system uses built-in cloud environment functionality and an external application programming interface (API) call back to the provider's API set up for this purpose. No provider functionality needs to be developed and deployed on the data-owner side in order to make this reduction in data flow across the network possible.

### BACKGROUND

Data owners often wish to have their data “activated,” i.e., enhanced with additional data, such as more complete contact data, other demographic data, or audience-relevant data, to enable more accurate messaging to their customers. The data may also be subject to “segmentation,” which means adding data that helps the data owner more precisely target a message to its customers by dividing the customers into similar segments, where similarity may be defined in various ways. For example, segments may be defined by geography or activity of the consumers. Typically, activation/segmentation requires the data owner to send the entire dataset to the service provider, which then sends the data back after it is enhanced. With extremely large datasets in the Terabyte range, the computational cost and time involved in sending this data back and forth becomes prohibitively expensive for certain applications. In addition, sending large datasets such as this across a network creates a privacy risk since there is always some risk that such data may be intercepted by bad actors, and these datasets typically include personally identifiable information (PII).

References mentioned in this background section are not admitted to be prior art with respect to the present invention.

### SUMMARY

The present invention, in various embodiments, provides a solution to the problems of data activation and segmentation that takes advantage of the fact that the great majority of datasets today are housed in a cloud-based data warehouse environment. Instead of sending across the entire dataset, only a single column of data, such as an anonymized customer identifier or household identifier, needs to be sent. The reduced data requirement is the result of the fact that computation is pushed down to the data owner's cloud-based data warehouse environment. This novel architectural approach dramatically reduces the amount of data being moved, and protects privacy because the only data being sent across the insecure network is anonymized data. All of the actual processing to make activation and/or segmentation occur takes place within the customer environment, rather than at the provider, using compute resources available within the customer's cloud computing environment. In certain embodiments of the invention, the implementation of the process takes advantage of built-in functionality in the cloud environment, as well as an external application programming interface (API) call back to the provider's API set up for this purpose. With the necessary functionality already existing in the data owner's environment, no provider functionality needs to be developed and deployed on the data owner side in order to make this reduction in data flow across the network possible.

In certain embodiments, an architecture for implementing the invention comprises an integration component and an activation component. The integration component may perform mapping of the consumer audience to a database resource; setting up data change capture functions to track changes in the audience of consumers for the desired message; and setting up user-defined external functions to fan out the data to the activation. The activation component involves setting up a task to dynamically compute the segment and fan out the data.

The invention, in various embodiments, enables the customer data in a cloud-based data warehouse to be activated natively in destinations by minimizing the data movement. The invention minimizes the data movement in between customer and downstream applications by providing a way to create segments on the data that the data owner maintains in its data warehouse and dynamically computes the segments to be pushed down to the destination via advanced, built-in provider-specific features. Because modern cloud-based data warehouse providers include these key features as pre-existing functions, various embodiments of the invention may be tailored specifically to a desired cloud environment or environments.

In certain embodiments of the invention, all of the compute and storage is on the cloud, and thus the invention provides a native data application on a modern data warehouse for reverse extract transform load (ETL) segmentation. In the traditional ETL data pipeline, data is first extracted from various sources, and then the extracted data is then transformed. This transformation can involve cleaning, aggregating, de-duplicating, or reformatting the data to ensure it's consistent and ready for analysis. Finally, the transformed data is loaded into a data warehouse, where it can be accessed for analysis and reporting purposes. Reverse ETL flips this traditional process. In a modern data stack, companies often aggregate their data into centralized, cloud-based data warehouses, but this data must be operationalized in order to use the insights gained from this data in day-to-day business operations. The reverse ETL process starts with extracting data from the centralized data warehouse, and then performing a transformation. However, this transformation is performed in order to suit the needs of various operational tools. Then, instead of loading into a data warehouse, the data is loaded back into operational systems like CRM (Customer Relationship Management) systems, marketing platforms, customer service tools, and other business applications. This allows for tailored messaging campaigns, enhanced customer service through real-time access to customer data, and optimization of sales strategies and decisions.

The present invention in certain embodiments allows activation and segmentation as part of this reverse ETL process.

These and other features, objects and advantages of the present invention will become better understood from a consideration of the following detailed description of the preferred embodiments and appended claims in conjunction with the drawings as described following:

### DRAWINGS

FIG. 1 is an architectural overview of a system according to an embodiment of the present invention.

FIG. 2 illustrates a workflow for a process implemented on the architecture of FIG. 1 according to an embodiment of the present invention.

FIG. 3 is a diagram of a computing environment according to an embodiment of the present invention.

### DETAILED DESCRIPTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

A system that provides an embodiment of the invention utilizes native features of cloud-based data warehouse environments. In one example, a data warehouse using the Snowflake® platform, from Snowflake Inc. is described. The Snowflake® environment will be used in the following examples for clarity, although the invention is not so limited. Other cloud providers have similar features, and the invention may be implemented in alternative embodiments on other cloud provider infrastructure, only some of which are specifically enumerated herein. Key features that the system according to various embodiments utilizes include the support Change Data Capture function; task scheduling; and the ability to make calls to external application programming interfaces (APIs).

Change data capture (CDC) refers to the process of identifying and capturing changes made to data in a database, and then delivering those changes in real-time to a downstream process or system. CDC was intended and is primarily used for preserving the state of a data warehouse, but is also available for other uses such as the use made by the system described herein. In the Snowflake® environment, the STREAMS function is used to provide CDC functionality, whereas change history may be used in the BigQuery® data warehouse environment provided by Google, for example. The STREAMS function creates a change table showing what changed, at a row level, between two transactional points on a dataset.

Task scheduling may be performed in the Snowflake® environment using the serverless tasks feature of that environment. Similarly, scheduled queries may be used for task scheduling in the BigQuery® environment. In addition to these key functions, there are implementational details that will be specific to each data warehouse environment, such as the language used to execute Data Definition Language (DDL) and Data Manipulation Language (DML) instructions to define data structures and to manipulate data, respectively.

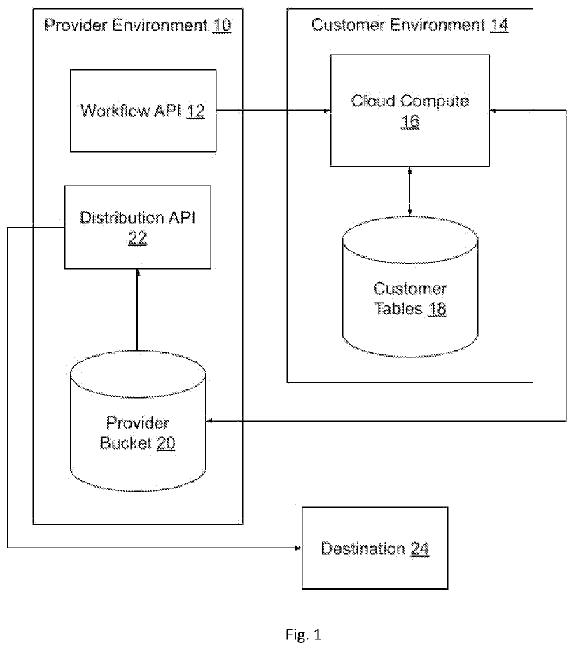

An overall architecture for a particular implementation of the invention may be described with reference to FIG. 1. Two computing environments, provider environment 10 and customer environment 14, communicate over a network. This network may be, for example, the Internet. A workflow API 12 within provider environment 10 is used to initiate a call in order to make use of computing resources customer environment 14. Cloud compute 16, within customer environment 14, provides the customer-located computing resources. Storage is provided with respect to cloud compute 16 by customer tables 18, which is also within the cloud-based customer environment 14.

Cloud compute 16 may also communicate with provider bucket 20 within provider environment 10. This allows for the manipulation of data back within the provider environment 10 by the computing resources within customer environment 14. A second API is provided in the form of distribution API 22, which can utilize data in provider bucket 20 in order to complete output tasks. These output tasks may be sent to destination 24.

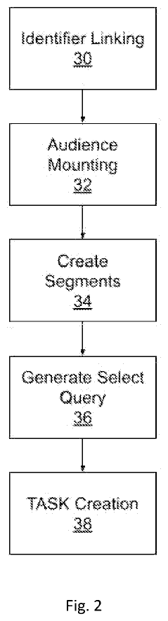

A workflow according to an implementation of the invention may be described as follows, with reference to FIG. 2, starting with the integration portion. A first step is the linking of the customer data warehouse to an internal customer identifier (ID) at identifier linking step 30. The customer begins by creating a service account that is linked to its organization and calls a stored procedure, herein called ‘nativeapp.auth_setup’. The stored procedure stores the service account in a safe way and lets other stored procedures for mounting the audiences and creating the segment use it to access the customer account.

The second step is audience mounting from database tables at audience mounting step 32. Once the authorization is done, the customer calls another stored procedure, herein called ‘nativeapp.mount_audience(TABLE_REFERENCE, AUDIENCE_ID_COLUMN)’ to link its Snowflake® tables at customer tables 18 to the provider's internal systems in provider environment 10. The stored procedure discovers the schema of the table and uses the service account to create relevant assets in the provider's internal metadata database stored at provider bucket 20. Once the audience is linked, the non-technical users such as marketers can access the asset inside the user interfaces that are used for creating the segments.

Historically, the provider's systems required the audience data to be moved to the provider's internal database for the internal user interfaces to operate on top of the audiences to activate the segments. This architecture virtually links the datasets to the assets in the customer silo and does not move any data outside of customer environment 14. The provider's system only stores the metadata of the assets in the customer environment 14, and syncs it when it changes over time as will be explained following.

A third step is creating segments from audiences at create segments step 34. While the audiences are mapped by technical people such as data analysts, the segment creation is often directed by non-technical people such as marketers. The provider environment 10 provides user interfaces for non-technical users to manipulate the audience data and create segments based on the criteria that they want.

The provider's segment builder, operating within customer environment 14 and using customer cloud compute 16, generates a structured query language (SQL) query such as follows: SELECT [user_identifier] FROM [audience_data] WHERE [segment_criteria]. This is performed at generate select query step 36. In one example, the [user_identifier] may be RampID®, the LiveRamp, Inc. technology for identity resolution. Each identifier within the RampID® system is uniquely matched to a particular entity within a universe of entities, such as consumers or households. The customer often uses a provider native app to resolve its PII data to RampID® identifiers before generating segments. The [audience_data] is the asset that the customer linked in the second step. The [segment_criteria] is programmatically generated based on the user input in the user interface.

The provider system generates a view for the segment query and links the view to the provider's internal metadata database within customer tables 18 in order to keep track of the segment data. The customer later distributes the segments to its activation channels, which triggers the provider's ETL systems to move [user_identifier] data from the customer environment 14 to the provider's internal databases at initial setup.

A fourth consideration is keeping the segment up-to-date with the source data. Often the customer may have its own ETL systems to update its data in its data warehouse, which results in changes on the [audience_data] table. As the internal data changes over time, the segment view that was generated also changes dynamically. The provider system may support segments that have billions of user identifiers but only a small portion of the data changes over time. In order to minimize the data movement and make the system more nearly real-time, the provider system keeps track of the changes using a feature called CHANGE_TRACKING, and creates a STREAM on top of the segment view to enable the CDC (Change Data Capture) mechanism explained above.

The provider system sets up a TASK in Snowflake® that is triggered in a scheduled way to pull the data from the STREAM to find out the new and deleted rows, which represents the users who entered and exited from the segments respectively. This is performed at TASK creation step 38. The user identifiers are saved to a Google Cloud Storage (GCS) bucket and an internal API, distribution API 22, that activates the segments is called from the stored procedure to send the data to destination 24.

In an embodiment of the invention, the amount of data movement required using traditional methods versus use with an implementation of the invention was explored. With a sample consumer dataset, which is believed to be representative of a common case, the embodiment of the invention achieved an 85% reduction in data movement across the network between the provider and data owner. The movement reduction is due to the fact that the only part of the dataset that is uploaded to the provider systems is the anonymized piece (such as an anonymized customer identifier or household identifier) and not the whole audience dataset. In other words, only a single column of the tabular dataset is required instead of transmitting the entire (often extremely large) dataset.

It will be understood that in addition to the reduction in data movement, and thus reduction of computational costs, the embodiment of the invention offers other advantages. For example, it is privacy sensitive because the full consumer dataset is not hosted by the provider. In addition, the system may operate in a more nearly real-time mode, thus enabling the activation and segmentation to be used with additional applications that are not compatible with the batch-mode operation of the existing systems. Another advantage is that because the system takes advantage of computational resources on the client side, rather than on the provider side, the infrastructure costs for the provider to build and maintain the system are significantly reduced.

In an example of an embodiment of the invention, a cloud-native data activation method comprises the steps of mapping a consumer audience comprising a plurality of consumer data stored in a cloud-based customer environment to a source database in a cloud-based provider environment, using a subset of the plurality of consumer data in the consumer audience sent from the customer environment to the provider environment, running a data change capture function in the customer environment, wherein the data change capture function tracks changes to the plurality of consumer data in the consumer audience, configuring within the customer environment user-defined external functions to activate the plurality of consumer data, and dynamically computing within the customer environment a set of segments for the consumer data, wherein the step of computing a set of segments comprises adding additional data to the plurality of consumer data, wherein the additional data is sent from the provider environment to the customer environment, enabling a customer to more precisely target a message to the consumer audience by dividing the plurality of customer data into similar segments.

In another example of an embodiment of the invention, a machine comprises one or more computer processors and a memory space having instructions stored therein, the instructions, when executed by the one or more computer processors, causing the one or more computer processors to, in a cloud-based client environment, link a set of audience data in a customer data warehouse to a set of internal customer identifiers, mount the set of audience data from a set of database tables stored within the cloud-based client environment, link the audience data to a cloud-based provider environment remote from the cloud-based client environment and connected to the cloud-based provider environment by a network, create a plurality of segments from the audience data by receiving input criteria through a user interface to manipulate audience data and create segments, and track changes to the plurality of segments in the audience data using a change data capture feature within the cloud-based client environment.

In another example of an embodiment of the invention, a method for cloud-based data activation comprises the steps of, in a cloud-based client environment, linking a set of audience data in a customer data warehouse to a set of internal customer identifiers, mounting the audience data from a set of database tables stored within the cloud-based client environment, linking the audience data to a cloud-based provider environment remote from the cloud-based client environment, wherein the cloud-based client environment and the cloud-based provider environment are in communication over a network, creating segments from the audience data by receiving input criteria from a user interface to manipulate audience data and create segments, and tracking changes to the segments in the audience data using a change data capture feature native to the cloud-based client environment.

In another example of an embodiment of the invention, a computerized system for cloud-native activation comprises a provider environment, wherein the provider environment comprises a workflow application programming interface (API), a distribution API, and a provider bucket in communication with the distribution API, and a customer environment in communication with the provider environment across a network, wherein the customer environment comprises a cloud compute cluster in communication with the workflow API and a plurality of customer tables in communication with the cloud compute cluster, wherein the cloud compute cluster is configured to perform operations on the customer tables in response to a request from the workflow API, wherein the workflow API is configured to initiate a call in order to utilize the cloud compute within the customer environment, wherein the cloud compute cluster is configured to link the plurality of customer tables to an internal customer identifier set, wherein the cloud compute cluster is further configured to link the plurality of customer tables to a set of provider data in the provider bucket to create provider metadata relevant to the plurality of customer tables in the provider bucket, without moving all data within the plurality of customer tables outside of the customer environment and into the provider environment, wherein the cloud compute cluster is further configured to create segments within the plurality of customer tables using data from the provider bucket in the provider environment, and wherein the cloud compute cluster further is configured to execute a change data capture function to track changes to the plurality of customer tables over time, and communicate metadata concerning the changes outside of the customer environment to the provider bucket in the provider environment.

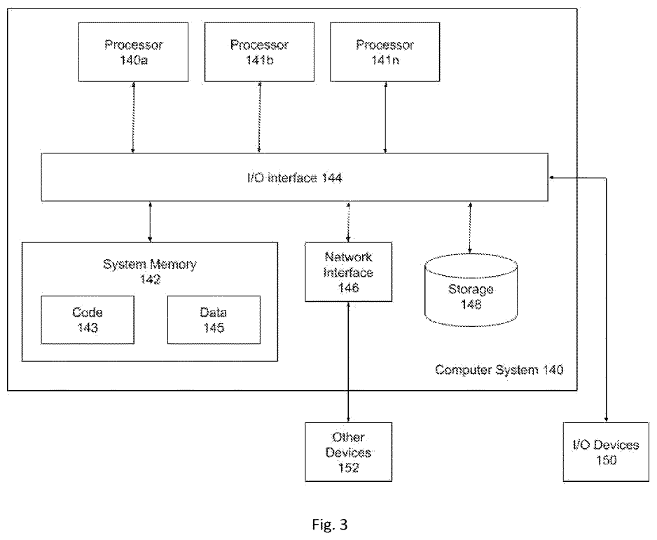

The methods described herein may in various embodiments be implemented by any combination of hardware and software. For example, in one embodiment, the methods may be implemented by a computer system (e.g., a computer system as in FIG. 3) or a collection of computer systems, each of which includes one or more hardware processors executing program instructions stored on a computer-readable physical storage medium coupled to the hardware processors, within the provider environment 10 and the customer environment 14. The program instructions may implement the functionality described herein (e.g., the functionality of various hardware servers and other components that implement the network-based cloud and non-cloud computing resources described herein). The various methods as illustrated in the figures and described herein represent example implementations. The order of any method may be changed, and various elements may be added, modified, or omitted.

FIG. 3, as previously referenced, is a block diagram illustrating an example computer hardware system, according to various embodiments. Computer system 140 may implement a hardware portion of a cloud computing system as forming parts of the various implementations of the present invention. Computer system 140 may be any of various types of hardware devices, including, but not limited to, a commodity server, personal computer system, desktop computer, laptop or notebook computer, mainframe computer system, handheld computer, workstation, network computer, a consumer device, application server, physical storage device, telephone, mobile telephone, or in general any type of computing node, compute node, compute device, and/or hardware computing device.

Computer system 140 includes one or more hardware processors 140a, 141b . . . 141n (any of which may include multiple processing cores, which may be single or multi-threaded) coupled to a physical system memory 142 via an input/output (I/O) interface 144. Computer system 140 further may include a network interface 146 coupled to I/O interface 144. In various embodiments, computer system 140 may be a single processor system including one hardware processor 141a, or a multiprocessor system including multiple hardware processors 141a, 141b . . . 141n as illustrated in FIG. 3. Processors 141a, etc. may be any suitable processors capable of executing computing instructions. For example, in various embodiments, processors 141a, etc. may be general-purpose or embedded processors implementing any of a variety of instruction set architectures. In multiprocessor systems, each of processors 141a, etc. may commonly, but not necessarily, implement the same instruction set. The computer system 140 also includes one or more hardware network communication devices (e.g., network interface 146) for communicating with other systems and/or components over a communications network, such as a local area network, wide area network, or the Internet. For example, a client application executing on system 140 may use network interface 146 to communicate with a server application executing on a single hardware server or on a cluster of hardware servers that implement one or more of the components of the systems described herein in a cloud computing environment as implemented in various sub-systems. In another example, an instance of a server application executing on computer system 140 may use network interface 146 to communicate with other instances of an application that may be implemented on other computer systems.

In the illustrated embodiment, computer system 140 also includes one or more physical persistent storage devices 148 and/or one or more I/O devices 150. In various embodiments, persistent storage devices 148 may correspond to disk drives, tape drives, solid-state memory or drives, other mass storage devices, or any other persistent storage devices. Computer system 140 (or a distributed application or operating system operating thereon) may store instructions and/or data in persistent storage devices 148, as desired, and may retrieve the stored instructions and/or data as needed. For example, in some embodiments, computer system 140 may implement one or more nodes of a control plane or control system, and persistent storage 148 may include the solid-state drives (SSDs) attached to that server node. Multiple computer systems 140 may share the same persistent storage devices 148 or may share a pool of persistent storage devices, with the devices in the pool representing the same or different storage technologies, including such technologies as described above.

Computer system 140 includes one or more physical system memories 142 that may store code/instructions 143 and data 145 accessible by processor(s) 141a, etc. The system memories 142 may include multiple levels of memory and memory caches in a system designed to swap information in memories based on access speed, for example. The interleaving and swapping may extend to persistent storage devices 148 in a virtual memory implementation, where memory space is mapped onto the persistent storage devices 148. The technologies used to implement the system memories 142 may include, by way of example, static random-access memory (RAM), dynamic RAM, read-only memory (ROM), non-volatile memory, solid-state memory, or flash-type memory. As with persistent storage devices 148, multiple computer systems 140 may share the same system memory systems 142 or may share a pool of system memories 142. System memory or memory systems 142 may contain program instructions 143 that are executable by processor(s) 141a, etc. to implement the routines described herein.

In various embodiments, program instructions 143 may be encoded in binary, Assembly language, any interpreted language such as Java, compiled languages such as C/C++, or in any combination thereof; the particular languages given here are only examples. In some embodiments, program instructions 143 may implement multiple separate clients, server nodes, and/or other components.

In some implementations, program instructions 143 may include instructions executable to implement an operating system (not shown), which may be any of various operating systems, such as UNIX, LINUX, Solaris™, MacOS™, or Microsoft Windows™. Any or all of program instructions 143 may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software or processing application) readable by a machine (e.g., a physical computer). Generally speaking, a non-transitory computer-accessible medium may include computer-readable storage media or memory media such as magnetic or optical media, e.g., disk or DVD/CD-ROM, coupled to or in communication with computer system 140 via I/O interface 144. A non-transitory computer-readable storage medium may also include any volatile or non-volatile media such as RAM or ROM that may be included in some embodiments of computer system 140 as system memory 142 or another type of memory. In other implementations, program instructions may be communicated using optical, acoustical or other form of propagated signals (e.g., carrier waves, infrared signals, digital signals, etc.) conveyed via a communication medium such as a network and/or a wired or wireless link, such as may be implemented via network interface 606. Network interface 146 may be used to interface with other devices 142, which may include other computer systems or any type of external electronic device.

In some embodiments, system memory 142 may include data store 145, as described herein. In general, system memory 142 and persistent storage 148 may be accessible on other devices 142 through a network and may store data blocks, replicas of data blocks, metadata associated with data blocks, and/or their state, database configuration information, and/or any other information usable in implementing the routines described herein.

In one embodiment, I/O interface 144 may coordinate I/O traffic between processors 141a, etc., system memory 142, and any peripheral devices in the system, including through network interface 146 or other peripheral interfaces. In some embodiments, I/O interface 144 may perform any necessary protocol, timing or other data transformations to convert data signals from one component (e.g., system memory 142) into a format suitable for use by another component (e.g., processors 141a, etc.). In some embodiments, I/O interface 144 may include support for devices attached through various types of peripheral buses, such as a variant of the Peripheral Component Interconnect (PCI) bus standard or the Universal Serial Bus (USB) standard, as examples. Also, in some embodiments, some or all of the functionality of I/O interface 144, such as an interface to system memory 142, may be incorporated directly into processor(s) 141a, etc.

Network interface 146 may allow data to be exchanged between computer system 140 and other devices attached to a network, such as other computer systems (which may implement one or more storage system server nodes, primary nodes, read-only node nodes, and/or clients of the database systems described herein), for example. In addition, I/O interface 144 may allow communication between computer system 140 and various I/O devices 150 and/or remote storage 148. Input/output devices 150 may, in some embodiments, include one or more display terminals, keyboards, keypads, touchpads, scanning devices, voice or optical recognition devices, or any other devices suitable for entering or retrieving data by one or more computer systems 140. These may connect directly to a particular computer system 140 or generally connect to multiple computer systems 140 in a cloud computing environment, grid computing environment, or other system involving multiple computer systems 140. Multiple input/output devices 150 may be present in communication with computer system 140 or may be distributed on various nodes of a distributed system that includes computer system 140. In some embodiments, similar input/output devices may be separate from computer system 140 and may interact with one or more nodes of a distributed system that includes computer system 140 through a wired or wireless connection, such as over network interface 146. Network interface 146 may commonly support one or more wireless networking protocols (e.g., Wi-Fi/IEEE 802.11, or another wireless networking standard). Network interface 146 may support communication via any suitable wired or wireless general data networks, such as other types of Ethernet networks, for example. Additionally, network interface 146 may support communication via telecommunications/telephony networks such as analog voice networks or digital fiber communications networks, via storage area networks such as Fibre Channel SANS, or via any other suitable type of network and/or protocol. In various embodiments, computer system 140 may include more, fewer, or different components than those illustrated in FIG. 3 (e.g., displays, video cards, audio cards, peripheral devices, or an Ethernet interface).

Any of the distributed system embodiments described herein, or any of their components, may be implemented as one or more network-based services in the cloud computing environment. For example, a read-write node and/or read-only nodes within the database tier of a hardware database system may present database services and/or other types of physical data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format. Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol. To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and sub-combinations possible of the group are intended to be individually included. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

We claim:

1. A cloud-native data activation method, comprising the steps of:
mapping a consumer audience comprising a plurality of consumer data stored in a cloud-based customer environment to a source database in a cloud-based provider environment, using a subset of the plurality of consumer data in the consumer audience sent from the customer environment to the provider environment;
running a data change capture function in the customer environment, wherein the data change capture function tracks changes to the plurality of consumer data in the consumer audience;
configuring within the customer environment user-defined external functions to activate the plurality of consumer data; and
dynamically computing within the customer environment a set of segments for the consumer data, wherein the step of computing a set of segments comprises adding additional data to the plurality of consumer data, wherein the additional data is sent from the provider environment to the customer environment, enabling a customer to more precisely target a message to the consumer audience by dividing the plurality of customer data into similar segments.

2. The cloud-native data activation method of claim 1, wherein the plurality of consumer data is organized into a plurality of rows and a plurality of columns, and the subset of the data in the plurality of consumer data comprises a single column of the plurality of consumer data.

3. The cloud-native data activation method of claim 2, wherein the single column of the plurality of consumer data comprises an identifier for each of the plurality of rows of the consumer data.

4. The cloud-native data activation method of claim 3, wherein the identifier is created by the provider, and uniquely associates each of the plurality of rows in the consumer data with a particular consumer.

5. The cloud-native data activation method of claim 1, wherein the data change capture function comprises a built-in function of the cloud-based consumer environment.

6. A machine comprising one or more computer processors and a memory space having instructions stored therein, the instructions, when executed by the one or more computer processors, causing the one or more computer processors to:
in a cloud-based client environment, link a set of audience data in a customer data warehouse to a set of internal customer identifiers;
mount the set of audience data from a set of database tables stored within the cloud-based client environment;
link the audience data to a cloud-based provider environment remote from the cloud-based client environment and connected to the cloud-based provider environment by a network;
create a plurality of segments from the audience data by receiving input criteria through a user interface to manipulate audience data and create segments; and
track changes to the plurality of segments in the audience data using a change data capture feature within the cloud-based client environment.

7. The machine of claim 6, wherein the instructions, when executed by the one or more computer processors, further cause the one or more computer processors to apply a linking procedure configured to discover a scheme of the audience data to create a set of relevant assets in a metadata database at the cloud-based provider environment.

8. The machine of claim 7, wherein the instructions, when executed by the one or more computer processors, further cause the one or more computer processors to generate a query comprising instructions for selecting a set of user identifiers, identify a location in the audience data, and identify a segment criteria.

9. The machine of claim 8, wherein the instructions, when executed by the one or more computer processors, further cause the one or more computer processors to utilize a provider native app to resolve the audience data to the set of user identifiers.

10. The machine of claim 9, wherein the instructions, when executed by the one or more computer processors, further cause the one or more computer processors to link metadata within the cloud-based provider environment to the segmented data to track the segmented data over time.

11. The machine of claim 10, wherein the instructions, when executed by the one or more computer processors, further cause the one or more computer processors to execute a task within the cloud-based provider environment to pull data from the cloud-based client environment identifying any new rows or deleted rows within the segmented data.

12. A method for cloud-based data activation, comprising the steps of:
in a cloud-based client environment, linking a set of audience data in a customer data warehouse to a set of internal customer identifiers;
mounting the audience data from a set of database tables stored within the cloud-based client environment;
linking the audience data to a cloud-based provider environment remote from the cloud-based client environment, wherein the cloud-based client environment and the cloud-based provider environment are in communication over a network;
creating segments from the audience data by receiving input criteria from a user interface to manipulate audience data and create segments; and
tracking changes to the segments in the audience data using a change data capture feature native to the cloud-based client environment.

13. The method of claim 12, wherein the step of creating segments comprises the step of applying a linking procedure to discover a schema of the audience data to create a set of relevant assets in a metadata database at the cloud-based provider environment.

14. The method of claim 13, wherein the step of creating segments comprises the step of generating a query comprising instructions for selecting a set of user identifiers, identifying a location in the audience data, and identifying a segment criteria.

15. The method of claim 14, wherein the query is a structured query language (SQL) query.

16. The method of claim 15, further comprising the step of utilizing a provider native app to resolve the audience data to the set of user identifiers.

17. The method of claim 16, wherein the step of linking the audience data to the cloud-based provider environment comprises the step of linking metadata within the cloud-based provider environment to the segmented data to track the segmented data over time.

18. The method of claim 17, further comprising the step of executing a task within the cloud-based provider environment to pull data from the cloud-based client environment identifying any new or deleted rows within the audience data.

19. A computerized system for cloud-native activation, the system comprising:
a provider environment, wherein the provider environment comprises a workflow application programming interface (API), a distribution API, and a provider bucket in communication with the distribution API;
a customer environment in communication with the provider environment across a network, wherein the customer environment comprises a cloud compute cluster in communication with the workflow API and a plurality of customer tables in communication with the cloud compute cluster,
wherein the cloud compute cluster is configured to perform operations on the customer tables in response to a request from the workflow API,
wherein the workflow API is configured to initiate a call in order to utilize the cloud compute within the customer environment,
wherein the cloud compute cluster is configured to link the plurality of customer tables to an internal customer identifier set,
wherein the cloud compute cluster is further configured to link the plurality of customer tables to a set of provider data in the provider bucket to create provider metadata relevant to the plurality of customer tables in the provider bucket, without moving all data within the plurality of customer tables outside of the customer environment and into the provider environment,
wherein the cloud compute cluster is further configured to create segments within the plurality of customer tables using data from the provider bucket in the provider environment, and
wherein the cloud compute cluster further is configured to execute a change data capture function to track changes to the plurality of customer tables over time, and communicate metadata concerning the changes outside of the customer environment to the provider bucket in the provider environment.

20. The computerized system of claim 19, wherein the cloud compute cluster is further configured to discover a scheme of the plurality of customer tables.

21. The computerized system of claim 20, wherein the distribution API is configured to execute a scheduled task to find any new rows or deleted rows in the plurality of customer tables in the client environment, and save any identifiers from the internal customer identifier set associated with the new rows or deleted rows in the provider bucket.
